(19) United States
(12) Patent Application Publication
(10) Pub. No.: US 2003/0102997 A1
(43) Pub. Date: Jun. 5, 2003

(54) Vehicle communication network

(75) Inventors: Moshe Levin, Tel Aviv (IL); Avraham Freedman, Tel Aviv (IL)

Correspondence Address: Robert D. Buyan, Stout, Uxa, Buyan, & Mullins, LLP, Suite 300, 4 Venture, Irvine, CA, 92618, US

(73) Assignee: Hexagon System Engineering Ltd., Tel Aviv (IL)

(21) Appl. No.: 10/244,201

(22) Filed: Sep. 16, 2002

Related U.S. Application Data
(63) Continuation-in-part of application No. 09/781,852, filed on Feb. 12, 2001, now abandoned.

(30) Foreign Application Priority Data
Feb. 13, 2000 (IL) 134518

(51) Int. Cl. G01S 13/93; G08G 1/16

(52) U.S. Cl. 342/57; 340/903; 340/902; 342/70; 342/357.1

(57) ABSTRACT

A vehicle communication system including a combined radar and wireless communication system coupling a plurality of vehicles. Preferably, the system also includes a plurality of access points which are coupled for wireless communication to the vehicles. There is also shown a method for vehicle communication including coupling a plurality of vehicles by means of a combined radar and wireless communication system.

### BACKGROUND OF THE INVENTION

1. Field of the Invention

The present invention relates to wireless communication and radar systems as well to collision avoidance, collision damage mitigation, adaptive cruise control and parking aid for vehicles and geographical information systems. The invention describes a nomadic communication system, which is capable of using the communication signal conveying coded information as a basis for radar waveform thus providing capability of a full pledged radar system.

2. Description of the Related Arts

Many vehicle radar systems for collision avoidance, collision mitigation, blind spot coverage, parking aid or adaptive cruise control aid, were developed in the last 30 years. See, for example, the discussions in [Levanon 88]: N. Levanon: Radar Principles, Wiley—Interscience, New-York, N.Y., 1988; [Rohling and Lissel 95]: Hermann Rohling, E. Lissel: “77 GHz Radar Sensor for Car Applications,” IEEE Inernational Radar Conference, Alexandria, Va. May 1995, pp. 373-379; [Woll 95]: J. D. Woll: “VORAD Collision Warning Radar”, IEEE International Radar Confrence, Washington D.C., 1995 pp. 369-372.

The complexity of the harsh operational requirements from such a vehicle radar system resulted in that, until today, radar systems are rarely installed in commercial vehicles. Their introduction is exceptionally slow in comparison to the continuous and overwhelming growth in the efficiency of related technologies, such as telecommunication and computing technologies.

The NAVSTAR Global Positioning System (GPS) is a satellite based radio positioning and time transfer system designed, financed, deployed and operated by the U.S. Department of Defense. The GPS provides for relatively high positioning accuracy, capability of measuring velocity and time and potential synchronization of independent units. The service is available all over the globe, 24 hours a day and free of any charge.

Wireless local area networks are well known. Local area networks (LAN) provide communications among computers connected to the same network, either directly or indirectly (via bridges and routers). The most common standard of such networks is based on the Ethernet standard, developed by the IEEE 802 group, and, in today's technology, it can provide communication on the order of 100 Mb/s.

An on-going effort in the community is the effort to develop and standardize wireless Local Area Networks (WLAN). Existing equipment is based on the IEEE 802.11 standard, and provides communication with data rates of 1-10 Mb/s. New standards are developed both in Europe (HIPERLAN2, developed by ETSI) and in the US (IEEE 802.11a), to enable WLAN operating at bit rates up to 54 Mb/s.

Many countries have initiated the development of infrastructure for future highways and other roads. The Deprtment of Transportation of the United States, in particular, is developing an Intelligent Transportation System (ITS). The project defines an architecture for that system, the serivces to be supported by it, and a set of standards to which such systems should comply. The communication sytem described in this invention is designed to comply with the relevant standard and support the ITS services, when applicable.

### SUMMARY OF THE INVENTION

The first object of this invention is to provide a communication system, which is capable of operating in two modes. The first is a standard high bandwidth (tens of Mbps) communication system. The second is a radar system, capable of supporting measurements in quality required for collision mitigation\avoidance and, at the same time, supporting a narrow band communication link. The system will integrate GPS measurements and GIS in order to improve the radar system performance and assist in its operation The second objective of this invention is to provide a communication/radar signal. This signal is capable of providing radar measures as well as multi-rate communication waveform.

The third objective of this invention is to provide a high level design of the communication/radar system based on the (IEEE 802.11a/HIPERLAN ETSI) WLAN standards and operating in the UNII/ISM bands (5.8 GHz preferably).

There is thus provided, in accordance with the present invention, a vehicle communication system including a combined radar and wireless communication system coupling a plurality of vehicles. Preferably, the system also includes a plurality of access points which are coupled for wireless communication to the vehicles.

There is also provided, in accordance with the present invention, a method for vehicle communication including coupling a plurality of vehicles by means of a combined radar and wireless communication system.

The invention makes use of specific radar signals, Multi-frequency Complementary Phase Coded signals (MCPC) introduced by N. Levanon in “Multifrequency Radar Signals”, Proc. IEEE Int'l Radar Conference, Alexandria, Va., May 2000 [Levanon 00]. These signals, are similar in structure to WLAN signals, thus enabling the dual use of the signals for both radar and communication.

### BRIEF DESCRIPTION OF THE DRAWINGS

The above and other objectives, features and advantages of the present invention will become apparent from the following description, taken in conjuncture with the accompanying drawings in which:

FIG. 1 is an artistic view of the invention. It describes the network concept, the two elements: vehicles (11) and access points (12) and the possible communication modes.

FIG. 2 is a view of the total system components describing the basic relation between the two subsystems.

FIG. 3 is a view of a typical application of the system as a radar mitigation system.

FIG. 4 is a view of a communication processor which depicts the main components required for communication processor implementation.

FIG. 5 is a view of the radar processor and the main components required for the radar implementation.

FIG. 6 is a view of a unified radar/communication processor according to one embodiment of the invention with dual mode operation.

FIG. 7 describes schematically the radar waveform.

FIG. 8 depicts an example of the resulting ambiguity function of a suggested radar/communication signal.

FIG. 9 depicts an example of the resulting cross-ambiguity function of two radar/communication signals.

FIG. 10 depicts the basic processing activities which take place in the radar processor, communication processor and information processor.

### DETAILED DESCRIPTION OF THE INVENTION

This patent application describes a wireless communication network, consisting of two types of elements: vehicles and access points. The network supports two modes of communication: stationary and in-motion. One of the features of this invention is a dual purpose system, installed in a vehicle and performing communication and radar functions. The suggested system is capable of measuring range, velocity and bearing of objects using communication signals. Once installed on a vehicle, the suggested system is capable of providing the information (range, velocity and bearing) required for collision avoidance, collision mitigation, pre-crash detection, adaptive cruise control or other system.

The suggested network and system enables vehicles to communicate with each other in order to exchange information that improves their safety, e.g., extending sensors capabilities, alerting on maneuvering, alerting on junction crossing, etc. It could serve other communication functions, like relaying information to other vehicles, as well as direct voice communication to nearby vehicles.

Vehicle to access point communication allows for connectivity of the car to the Internet, thus allowing information pushing (e.g. local maps) and information pulling (e.g. car maintenance application). The suggested system includes an optional GIS (Geographical Information System), which is capable of improving the system performance by predicting curves in the road and adjusting the waveform and antenna patterns to cope with these curves. The prediction is done by projecting GPS measurements on road maps. The information provided by the GPS/GIS subsystem will alleviate the radar sensor requirement, and it is expected to lower the total system cost significantly. Alternatively, or in addition, rate gyro information can be fused with other data so as to predict road curves and adjust the antenna patterns to improve the radar performance. Rate gyros provide information about changes of velocity and acceleration, and can thus indicate to the radar that the vehicle is entering a curve. The radar can use that information to adjust the radar beam direction to point at the road rather than to objects outside. The system is envisioned to be integrated with other sensors within the modern vehicle and with the future highway infrastructure, such as the Intelligent Transportation System (ITS).

It is a particular feature of the invention that it utilizes a vehicle radar system. A radar system can be used in a vehicle to accurately detect hazardous conditions and react accordingly. Such a system will improve the safety of the vehicle, either by alerting the driver to potentially dangerous conditions, or by operating the vehicle driving system autonomously when “man in the loop” control does not cope with the required response time.

Radar has several advantages over other types of sensors, such as laser radars, sonars (ultrasonic devices), infra-red (optical devices), video, etc. These advantages can be summarized in the following table, taken from [Woll 1995]

| Technologies | Ultra- | Infra- | Lidar | | |
|---|---|---|---|---|---|
| Feature | sonic | Red | (Laser) | Video | Radar |
| Long Range Capability | Poor | Fair | Good | Good | Good |
| Target Discrimination | Poor | Poor | Fair | Good | Good |
| Minimizing False Alarm | Poor | Poor | Fair | Fair | Good |
| Temperature Stability | Poor | Fair | Good | Good | Good |
| Darkness Penetration | Good | Good | Good | Poor | Good |
| Adverse Weather Penetration | Poor | Poor | Poor | Poor | Good |
| Potential low cost hardware | Good | Good | Fair | Poor | Good |
| Low cost DSP | Good | Good | Good | Poor | Good |
| Sensor Dirt/moisture | Fair | Poor | Poor | Poor | Good |
| performance | | | | | |

The radar system can be visualized as a range/velocity/bearing sensor, which monitors the moving obstacle in front and alongside the vehicle, all with a reasonable level of false alarm. Such a sensor preferably will create a full three dimensional map of the potential obstacles and dangerous objects. The radar output will include a list of obstacles/objects with their dynamic parameters, called: the track file.

The main sensor requirements for a car radar system are listed in [Rohling and Lissel 1995]:

Sufficient maximum range and high sensitivity

Simultaneous measurement of objects range and relative radial velocity.

Multi target sensing capability

High measuring update range

Large coverage in azimuth with good discrimination.

Small sensor dimensions and mounting without impact on styling.

Resilience to bad weather, dirt and other contamination.

Low cost at large production volumes.

The radar performance is derived from the vehicle possible dynamic and safety requirements.

The present invention will now be described with reference to the accompanying drawings.

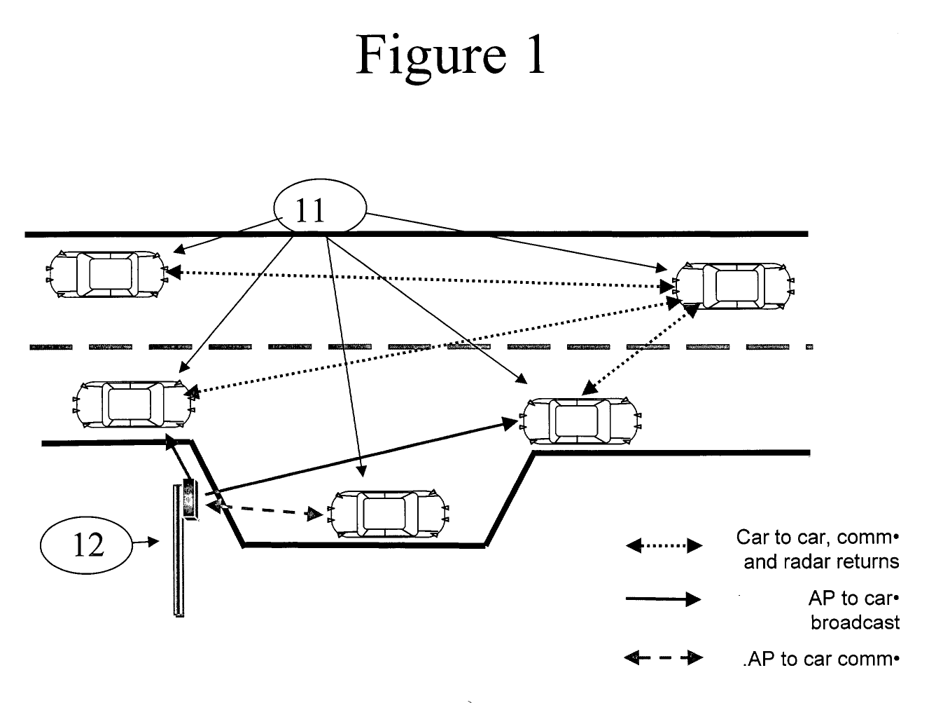

FIG. 1 depicts the network concept: We can see in this figure the vehicle system 11 and the access points 12. The system is implemented by software radio concept, in which functions are implemented by digital signal processors as much as possible. This means that the number of specially tuned analog components is reduced as much as possible, and most of the processing functions are performed by programmable devices, thus enabling the radio to change its characteristics and functions, according to the relevant mode.

For vehicle applications, the system will operate in two modes: The communication mode and the radar mode. While the vehicle is moving, the radar mode is operating, and the system provides an additional communication channel with bandwidth of up to 1 Mbps. This channel will be used for communication between vehicles for two applications: first—communication to improve the sensors' view (e.g. the track file—list of “targets” and targets parameters—to be transferred between vehicles). Secondly, the communication link is used to share information relevant to synchronized operation of adjacent vehicles, like platoon operation (a number of vehicles moving in a tight constellation) and inter system interference reduction.

It is a particular feature of the present invention that car safety is improved by coordinating the operation of different vehicles which are close to one another, in order to prevent collisions, etc. Sensor information can be shared via radar communication, car safety can be improved by coordinating the operation of sensors, or by coordinating the operation of the various radar sensors, in order to limit the mutual interference problem. For example, forthcoming maneuvering can be reported by one car to another. While conventional radar systems do not rely on external information to detect and track their targets, the proposed radar system will use information coming from other vehicles to enhance its performance. Here are two examples:

A major source of interference is the radar of another vehicle operating in the same neighborhood. By allowing a communication channel between different vehicles, the radar operation could be coordinated such that the interference is minimized.

A radar system tracks its targets in order to predict their trajectory, and detect collision danger. In order to track a manuvering target, the radar has to perform measurements of the target in high rate, and allow for a large prediction error. In radar terms, the radar has to dedicate a lot of resources for that particular target, resources that cannot be given to other targets. Cooperating targets, like vehicles equipped with the equipment described herein, can provide maneuvering information to the tracking radar, and thus reduce the amount of resources required for that target. The radar would than be able to use those resources to detect and track other targets.

Special care was taken to enhance the system operation in a multi system environment. Radar systems are vulnerable to intersystem interference, due to the high signal attenuation of the two way signal path, in comparison to one way of the interfering signal path. The suggested signal uses conventional non-linear signal processing and filtering techniques to reduce the impact of other system interference.

One specific embodiment of the invention described in this patent application is a system based on the physical layers of Wireless LAN systems standardized by the IEEE in IEEE 802.11a and by the European ETSI as HIPERLAN 2. The system will have a radar mode for moving systems and standard HIPERLAN2/IEEE 802.11a mode for high speed communication (with net data rates up to 54 Mbps) when the system is stationary. In this case, the vehicle can be connected to a central site.

The suggested system is capable of operating in two of the three unlicensed bands—the 2.4 GHz region and the 5.4 GHz/5.8 GHz region. As such, the system will be able to leverage the huge investment in those RF bands.

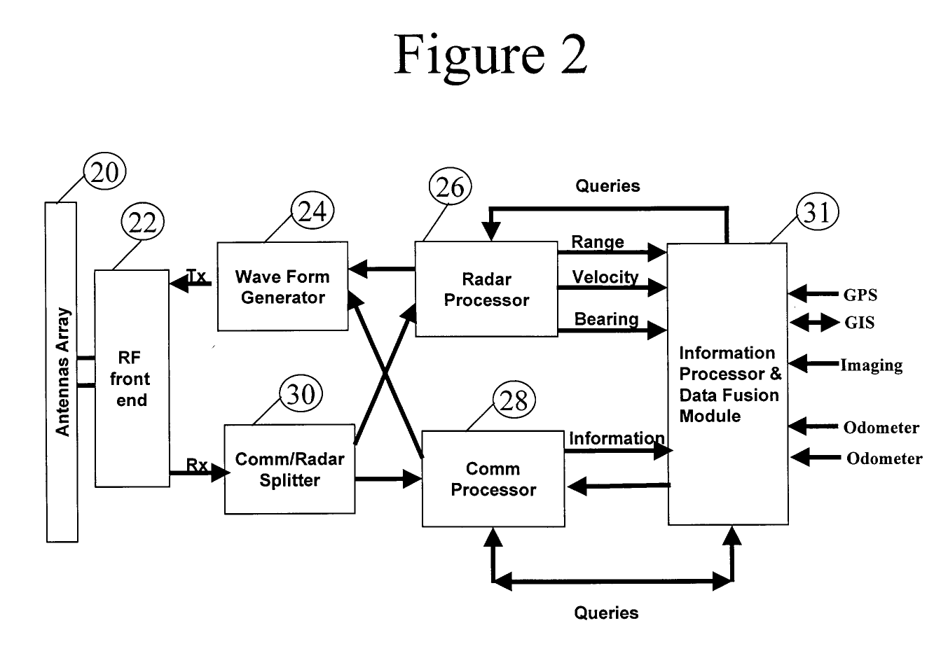

FIG. 2 is a schematic system overview for describing the high level concept of the system. The system consists of the following elements. An antenna array 20, which consists of at least one antenna. The antenna array 20 will be used to provide spatial resolution between radar targets, measurements of bearing to the targets, as well as cancellation of unwanted interfering signals.

An RF front end 22 is coupled to antenna array 20. RF front end 22 transmits the required waveforms and receives the radar echo or the incoming information transmission.

A waveform generator 24 is coupled to RF front end 22. The waveform generator 24 receives, from a radar processor 26 and a communication processor 28, the required waveforms and the information to be transmitted. The waveform generator 24 synthesizes a combined waveform to be transmitted by the RF front end 22.

A Comm/Radar splitter 30 is coupled between RF front end 22 and Communication processor 28. Comm/Radar splitter 30 splits the received signal to a radar signal (by canceling the known transmitted information signal out of the received signal) and a communication signal (by canceling the radar signal). Each of these filtered signals is conveyed to the appropriate processor—the radar processor 26 or the communication processor 28.

Radar processor 26 analyzes the raw data received by the RF front end 22. The radar processor performs target detection using digital radar signal processing and constructs the three-dimensional Range-Doppler-Azimuth map. The radar processor produce track files, each representing the dynamic of a near by object and alerting as to potential hazardous objects.

Communication processor 28 supports the communication link. In ISO's OSI model definition, the communication processor supports the six lowest layers out of the seven communication layers. The seventh layer, the application layer, is handled in an information processor 31. The information processor 31 will support existing communication standards in the relevant frequency bands.

In the illustrated embodiment, information processor 31 includes a data fusion module. The information processor controls the radar and communication processor and processes their output. This processor translates the track files results into the appropriate information for the various automotive subsystems (like the steering and braking systems etc.) The data fusion module receives information from various sources: the radar measurements, the communication channel providing it with information about other vehicles (possibly including their position and manuvering etc.), and the vehicle's on board instruments, such as a GPS, odometer etc. The data fusion modules creates a unified picture of the environment out of the received data. For example, the radar provides it with a list of targets, each with its range, velocity and bearing. The data fusion module, using its own vehicle data, places the targets on a map built in memory, and tries to identify the data coming from the communication channel with the targets found on the map. If there is a positive identification, the estimate of the target position and manuvering can be greatly improved.

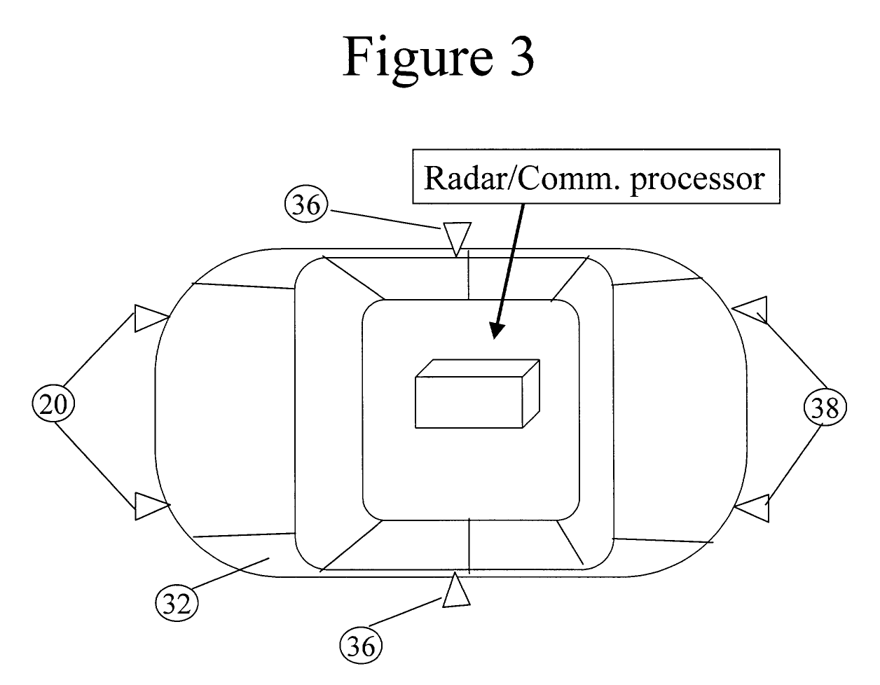

FIG. 3 displays one embodiment of a typical configuration of the above subsystem in a vehicle 32 for collision mitigation application. In the implementation example depicted in FIG. 3, two antennas 34 cover the front of the vehicle. More than one antenna is preferred, so as to ensure the required resolution. Four optional antennas 36, 38 cover the sides and the back of the car and they can be used to improve the car's active safety (maneuvering instead of braking), and as a warning system while driving backwards. The exact number of antennas utilized, and their location, is the result of an engineering process which takes into account the transmitted frequency, the required azimuth resolution, and the structure of the car front. A combined radar/communication processor 39 is located in the computer of the vehicle.

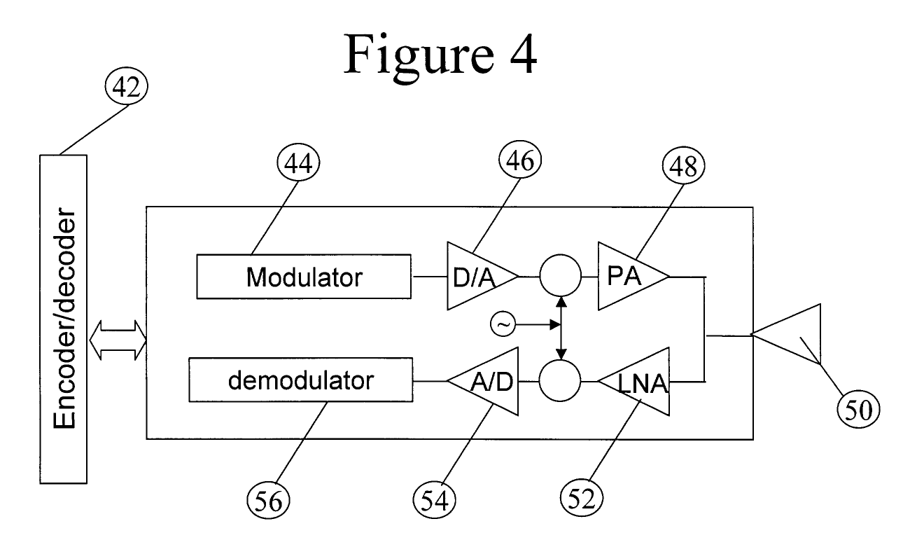

FIGS. 4 to 6 depict several embodiments of radar and communication processors, which allow for efficient implementation of the invention.

FIG. 4 depicts a communication processor 40 which consists of two channels: a transmitting and a receiving channel. On the transmitting channel, is an encoder/decoder 42 which encodes the information to be transmitted, a modulator 44 which modulates the said encoded information, a digital to analog (D/A) converter 46 which converters the modulated digital signal to an analog signal and a power amplifier (PA) 48 which amplifies the analog signal and transmits it to an antenna 50.

On the receiving channel, is a Low Noise Amplifier (LNA) 52, which amplifies the received signal. An A/D (Analog to Digital) converter 54 samples the analog signal and converts it to a digital signal. A demodulator 56 demodulates the digital signal and conveys it to the decoder/encoder 42, which decodes the information.

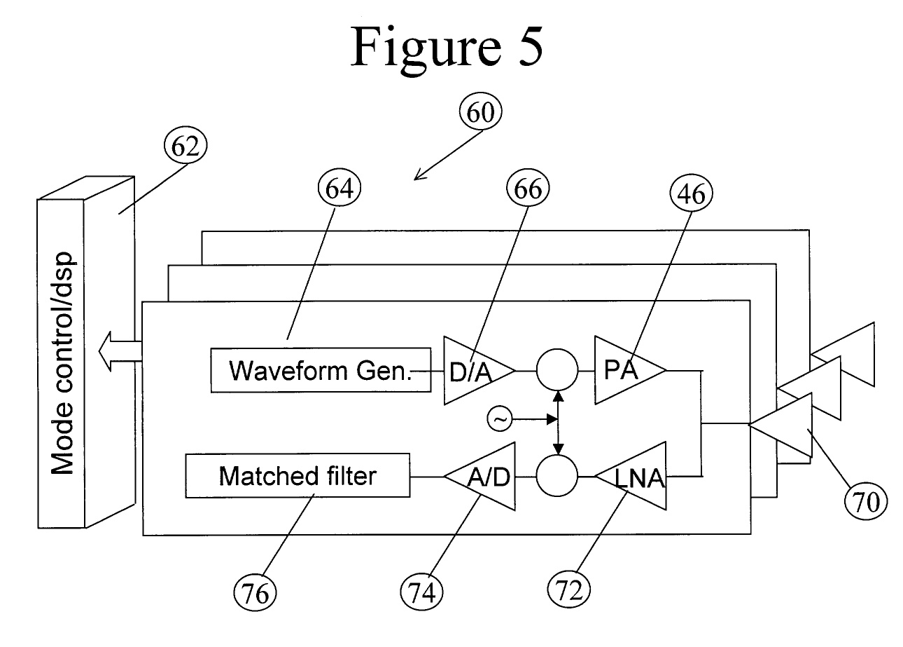

FIG. 5 shows a general system radar processor 60 using several antennas. Each antenna has its own transmitter and receiver. A mode control 62 sets the operation mode (Full Track, Track While Scan, Emergency etc.). A waveform generator 64 generates the appropriate waveform and a D/A converter 66 converts it to an analog signal. A power amplifier 68 amplifies the resultant signal and conveys it to an antenna 70. On the receiving channel, a Low Noise Amplifier 72 and A/D converter 74 are provided, coupled to a matched filter 76, which is used to optimally extract the echo signal from the noise. These functions are performed in each of the modules attached to an antenna.

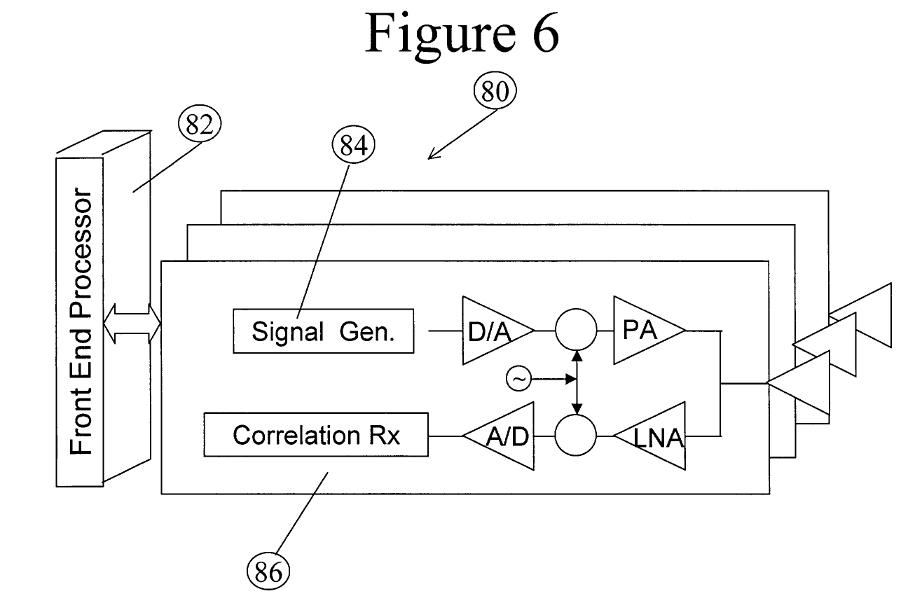

FIG. 6 depicts a generalized radar/communication processor 80 corresponding to the invention. A front end processor 82 serves both as encoder/decoder for communication and as mode control for radar. A signal generator 84 performs both modulation (for communication) and waveform generation (for radar), which are related operations. A correlation receiver 86 provides the functionality of matched filter and demodulator (as with the signal generator, these are similar operations for extracting signals from noise).

Operation of the radar processor is as follows. The radar signal processing is based on the pulse Doppler radar. This type of radar implements a coherent pulse train which lends itself to simple digital radar processing and DSP-based radar processors.

Since various velocity resolutions are required, the radar processor performs five coherent integration operations concurrently, over 2, 4, 8, 16 and 32 pulses. Each of these integrations will provide a different velocity resolution with different time response. Using this concept, the radar processor is able to handle low and fast targets.

Typical requirements of a preferred embodiment of such a radar system, taking into account link budget and parameter considerations, are as follows:

Range

Minimum range—5 m

Maximum range—150 m

Range resolution—10 m

Velocity

Minimum velocity—0 m/s

Maximum—120 m/s (˜430 km/h)

Resolution—10 m/s for very high velocities (V>60 m/s)

4 m/s for high velocities (60 m/s>V>30 m/s)

2 m/s for medium velocities (30 m/s>V>10 m/s)

1 m/s for low velocities (10 m/s>V>4 m/s)

0.5 m/s for very low velocities (V<4 m/s)

Wave Length (λ)

The carrier frequency is 2.45 GHz or 5.8 GHz. The appropriate wavelength is 0.1224 m and 0.0517 m respectively. In the following example, we will evaluate the embodiment of this concept in 5.8 GHz ISM band.

Antenna Gain (G)

Antenna gain is derived from the size of the antennas. Typical reasonable values are 20 dBi.

Transmitted Average Power (P_{T})

In order to comply with the 5.8 GHz ISM band, the EIRP power should be lower then 36 dBm, assuming antenna gain of 20 dBi, the transmitted power should be 16 dBm.

Pulse Duration (tₚ)

The suggested pulse duration is 208 μsec. The pulse will be constructed from 52 chips (sub pulses) of 4μ each.

Bandwidth

The bandwidth of the signal is derived from the required range resolution. For range resolution of 10 m, the required time resolution is 66 nanoseconds. The resulted bandwidth required is 16 MHz.

Pulse Repetition Frequency (PRF)

The PRF is derived from the maximum velocity required. The Doppler shift of a target moving at 120 m/s is given by: f_{d}=2Vₘₐₓ/λ=2.120/0.0517=4640 Hz. In order to avoid aliasing, the PRF should be at least 4640.2=9280 Hz which result in a PRI (Pulse Repetition Interval) of around 100 μsec which is lower than the pulse duration calculated earlier. Hence, the system will use multiple PRF technique to resolve ambiguity. The selected PRF will be 0.66 Khz and 0.5 Khz which is PRI of 1.6 ms and 2 ms respectively. The duty cycle will be 10% and lower.

Pulse Repetition Interval (PRI)

The pulse repetition interval is limited by the range ambiguity set by the maximum range. Using PRI>2*maximun range/C, we note that the PRI suggested above (1600 μsec) will provide a range ambiguity 240 km.

Frequency Resolution

The frequency resolution is derived using the relation Δf=(2·Δv)/λ. The following table provides the resulted frequency resolution for various operation modes:

| Operation mode | Δv (m/s) | Δf (Hz) |
|---|---|---|
| Very high | 10 | 386 |
| velocities | | |
| High velocities | 4 | 156 |
| Medium velocities | 2 | 77 |
| Low velocities | 1 | 38 |
| Very low velocities | 0.5 | 19 |

Number of Pulses (N)

The number of pulses set the coherent processing time, which is derived from the size of the frequency resolution cell: 1/(N·PRI)=Δf. The following table provides the required number of pulses.

| | | Integration | |
|---|---|---|---|
| | | Duration | |
| Operation mode | Δf (Hz) | (ms) | N |
| Very high | 386 | 2.6 | 2 |
| velocities | | | |
| High velocities | 156 | 6.4 | 4 |
| Medium velocities | 77 | 12.8 | 8 |
| Low velocities | 38 | 25.6 | 16 |
| Very low velocities | 19 | 51.2 | 32 |

The single pulse SNR (Signal to Noise Ratio) is calculated using the radar equation [Levanon 88]. Note that in this case the calculation should take into account the ground effect which yields a pessimistic estimation of the SNR (attenuation with the eighth power of the range compared to fourth for free space radar range).

For the parameters described earlier, the SNR for single pulse at the maximum range is 28.5 dB for a car target (RCS=100 m²) and 8.5 dB for a man target (RCS=100 m²). Assuming that man targets do not appear at very high velocities (V>60 m/s), we can calculate the SNR at the output of the coherent integrator. The radar system parameters are given in the following table:

| Parameter | Value |
|---|---|
| Transmission Power - P_{T} | 20 dBm |
| Antenna Gain - G | 16 dBi |
| Antenna Heights Hₜ, Hₛ | 1 m |
| Radar Cross Section RCS | 1 m² (man); |
| | 100 m² (car) |
| System losses | 5 dB |
| Noise Figure | 2 |
| Signal Bandwidth f_{B} | 16 MHz |
| Range | 150 m |

The resulting SNR values are given in the following table (in dB):

| | | Car | Man |
|---|---|---|---|
| Operation mode | N | Target | Target |
| Single pulse SNR | 1 | 28.5 | 8.5 |
| Very high | 2 | 31.5 | — |
| velocities | | | |
| High velocities | 4 | 34.6 | 14.6 |
| Medium velocities | 8 | 37.6 | 17.6 |
| Low velocities | 16 | 40.6 | 20.6 |
| Very low velocities | 32 | 43.6 | 23.6 |

It is clear from this table that the system is capable of detecting people at the maximum range (150 m) with reasonable probability of detection, under a reasonable probability of false alarm.

The Radar Signal, its Ambiguity and Cross Ambiguity

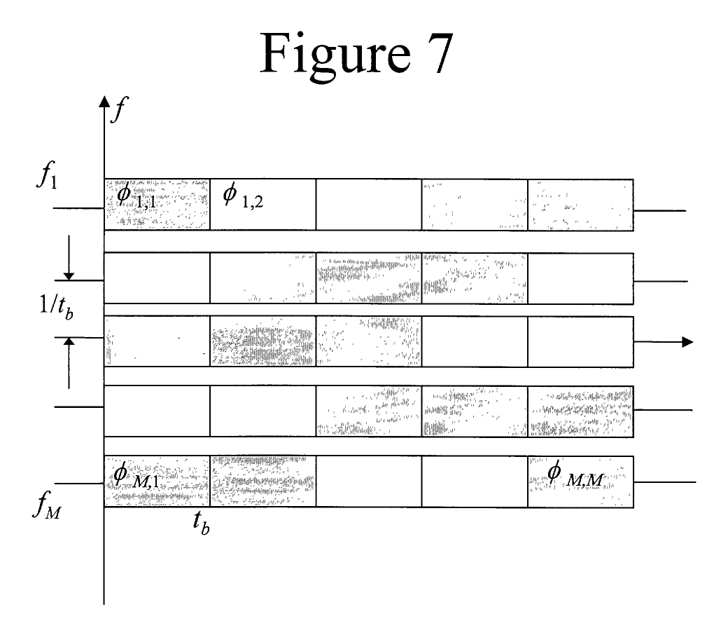

The radar signal is depicted in FIG. 7, taken from [Levanon 00]. The signal comprises of simultaneous transmission of a set of M signals. Each of those signals is a sequence of pulses, each modulated by a specific sequence of phase modulated pulses, chosen such that the autocorrelation and cross correlation of the sequences is complementary, as described in [Levanon 00].

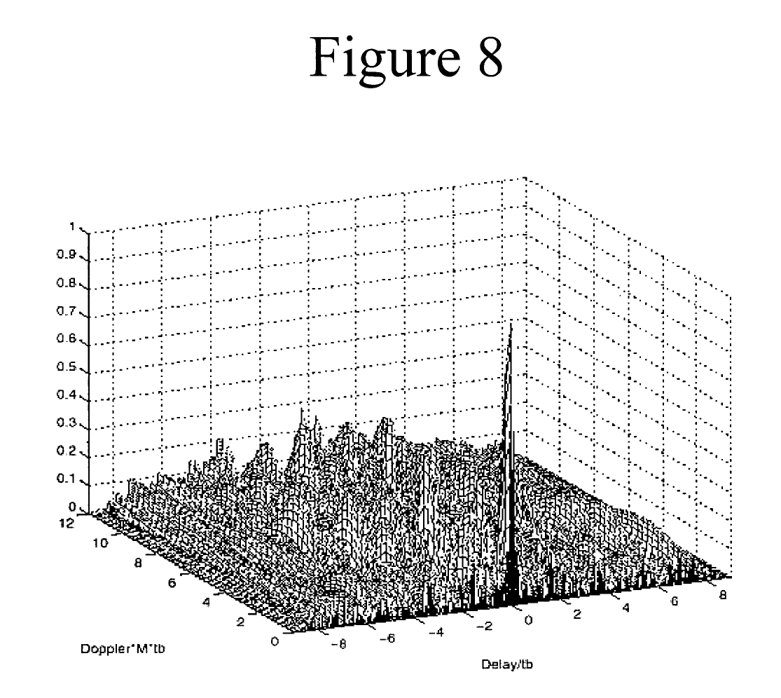

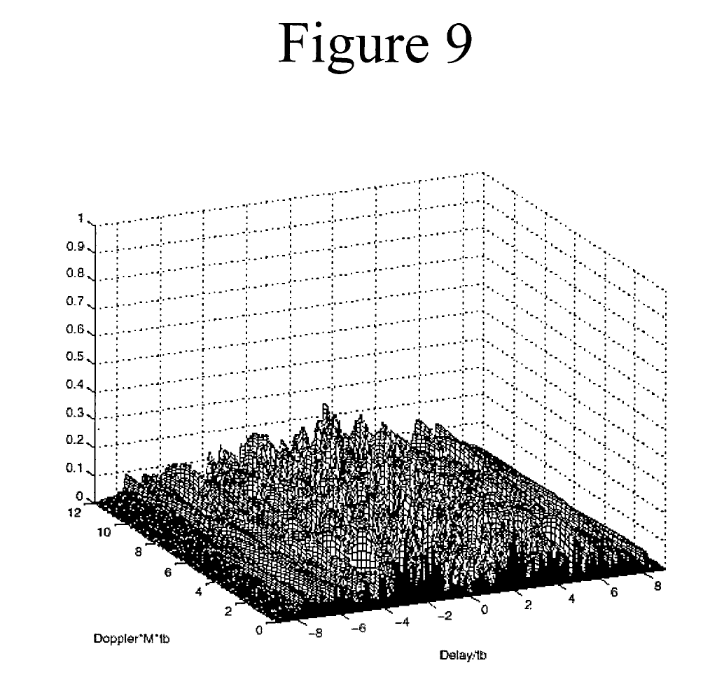

The ambiguity function is a measure to the resolution of a given radar waveform. FIG. 8 provides the ambiguity function of the suggested communication/radar signal. The cross-ambiguity function (shown in FIG. 9) depicts the attenuation of signal with coding different from the reference signal.

Operation of the communication processor is as follows. The communication processor will operate in two distinct modes: stationary and in-motion. When moving, it will use the radar waveform, in a way unique to this invention, for communication purposes as well.

The stationary mode involves communication using standard protocols, such as HIPERLAN 2 or IEEE 802.11a, with commercial access points located at gas stations, rest areas at homes etc.

The standards mentioned above specify the two first layers of the ISO OSI model, namely, the Physical and the Link layers. The application layer in the information processor shall use standard implementations for the rest of the layers, e.g. IP protocol for the Network layer, TCP protocol for the transport, telnet and FTP for the session layers.

The physical layer for the above mentioned standards makes use of an OFDM signal, composed of 52 carriers spaced 0.3125 MHz apart. Each carrier is modulated by a QPSK, 16-QAM or 64 QAM signal. Scrambling and forward error correction are applied, as well, to ensure error free communication. Depending on the choice of the modulation scheme and error correction code rate, the net data rate ranges from 6 Mb/s to 54 Mb/s.

The medium access control layer is also specified in the above mentioned standards. However, there are different specifications for that layer in various standards. The communication processor will be able to handle various protocols.

As the vehicle pulls into a rest area or gas station, the stationary mode will be activated, the processor will form a link with the access point and start a communication session, as instructed by the information processor.

The communication ranges within a rest area are small, so a high data rate, close to the maximum possible, can be used. The available channels should also be shared among a limited number of users who stay in the area. The expected rate of such a user, using the parameters of present WLAN techniques, can reach about 10 Mb/s.

As the stay in such a rest area is limited to a few minutes, the amount of information that can be transferred is on the order of hundreds of Mbits, enough for transfer of maps and local information to the vehicle, and transfer status of the vehicle to a maintenance center. It can also support Internet access to the user.

It is expected that the access point will handle two types of transmissions. Broadcast transmissions, which transmits local maps and information to all vehicles, and custom transmission to each individual vehicle.

In the in-motion mode, on the other hand, the communication processor uses the radar waveform to communicate. Unlike conventional communication modulation techniques, here the information is modulated by the choice of a particular waveform. The radar waveform uses the same signal structure as the WLAN, with, for example, 52 OFDM carriers, however the choice of modulation per carrier is determined by the radar requirements, namely each of the signals transmitted on a said carrier must be a complementary phase modulated signal. In a particular embodiment of the invention, the radar waveform uses a number of symbols that equals the number of carriers, and can be chosen from a set of M! possibilities, where M is then number of carriers. This method opens up the possibility of conveying information on the order of magnitude of log₂[(M−1)!] bits.

While it is important for good radar performance, that each signal transmitted on each carrier is a complementary sequence, the specific assignement of sequences to carriers is not important. This degree of freedom that can be used to convey information. A possible choice of communication wavefrom can be as follows. Let us assume that the phase sequences transmitted in each carrier are denoted by {s₁, . . . ,s_{M}}. The first [log₂ M] bits of the message to be transmitted (where [x] means rounding x to the nearest integer snaller than x) determines the choice of sequence sⱼ for the first carrier. The index j is selected according to those bits. The next [log₂ (M−1)] bits determine the choice of the second sequence, the next [log₂ (M−2)] bits determine the next sequence, and so on.

For a specific embodiment, if 52 carriers are used, the first 5 bits will select one of 32 (out of the available 52) sequences. The sequences will then be reordered in a predetermined manner and the next 5 bits will select another one out of 32 (out of available 51) sequences. The procedure will continue until only 31 sequences remain to be selected, then, 4 bits will be required to select one out of 16 out of the available 31 sequences, the next 4 bits will select one of 16 sequences and so on. The last sequence will be selected by default.

It is expected that some of the carriers will be pre-selected to enable the receiver to perform channel estimation. This will reduce the number of information bits to be transmitted.

Upon reception the communication processor identifies the particular sequence transmitted in each carrier, and re-assembles the transmitted bit stream.

Taking into account that the radar transmission is not continuous, and bearing in mind that bits should also be dedicated for coding and overhead, the available information transfer could be as high as 1 Mb/s, using the WLAN parameters.

The time allocated for radar reception is relatively short, and following that time, the receiver could be tuned to reception, scanning all available channels for activity. It could detect transmission from other cars, operating in the in-motion mode, or from fixed access points (when passing by gas stations and rest areas where such access points are located)

Once activity is detected, the communication processor will initiate a session with other cars using a protocol which could be peer-to-peer protocol, or picocell protocol, or any other suitable protocol.

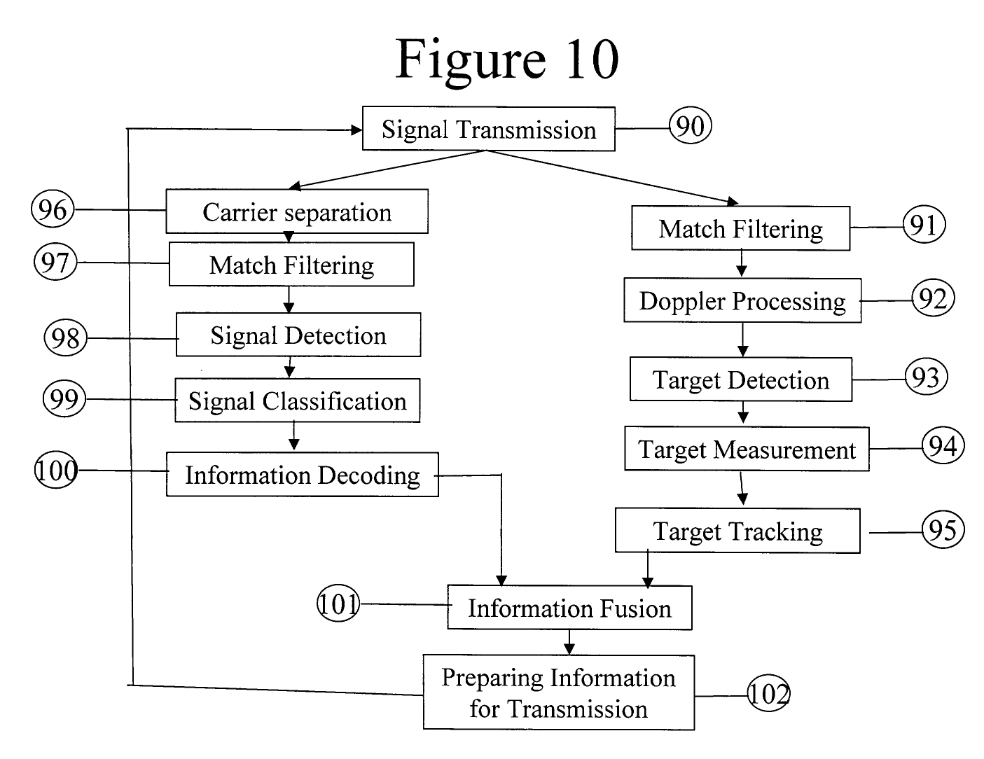

FIG. 10 describes the activities of all the processing units during in-motion operation. The received signal is split to both radar and communication processor 90. Within the radar processor the received signal is first processed received by a filter 91 matched to the entire transmitted waveform. Following that, it goes through Doppler Processing 92 which computes using the returns fo several transmission pulses the signal strength in different range and Doppler cells. Based on this computation, the radar processor detects the target 93 and then measure its range and Doppler 94. The result of the measurements are transferred to the information processor which performs tracking of targets already known to it 95. The algorithms and procedures used for each of those activities are described in [Levanon 88] and other textbooks known in the art. The radar information is then fused with other information 101.

In parallel, the communication processor performs its own processing stages. The signal is separated to its individual carriers 96, and each carrier is treated as a seprate signal which is match filtered to s single pulse waveform 97. The presence of a viable signal is detected 98 and the signal is classified 99 to be another in-motion mode signal, a self signal echo or a stationary mode signal transmitted by an access point or a stationary vehicle. According to the signal class the information is extraced 99 and transferred to the information processor for fusion 100. The extraction of information involves a set of activities which is described in various textbooks in the field of digitial communication, including channel estimation, channel equalization error correction etc.

Based on the information available, the information processor prepares the next transmission 101. The pulse repetition interval is determined according to the expected radar processing requirements, while the information to be transmitted determines the sequence order as described above.

The communication link established could be used for various purposes:

Exchange of vehicle position, speed and heading.

Exchange and coordination of radar parameters (frequency, timing etc.) to enable operation without interference.

Exchange of radar data (obstacles, other cars on the road)

Information relay, used for relaying local information not available to the vehicle information processor.

It will be appreciated that each access point in the network, which communicates with stationary vehicles and with vehicles in motion, can provide point of presence (POP) to the Internet. In addition, the network preferably includes software so that each point can provide push/pull information service, or broadcast services.

When transmissions from a fixed point is received, reception could be transferred to the standard protocol used by that fixed point, while, when in motion, transmission is limited for radar purpose alone. Passing by such a point of general information, broadcast by that point can be received and used. As fixed point transmissions are limited in range, the amount of data that can be received is limited. For example, for 300 m usable range, a car passing by such a point in maximum speed of 50 m/s will be within the usable range for approximately 12 seconds, thus limiting the amount of information which can be transferred to 120 Mbits.

According to one embodiment of the invention, a sub-system is provided in the access point and/or vehicle, which is capable of pushing/pulling large information blocks by dividing them into several sub blocks, transitioning/receiving each sub-block in a separate access point, and automatically combining it in the vehicle/access point. This describes a possibility to use the system to transfer a large amount of information, if needed. If such a large amount is requested, it should be partitioned into small sub blocks, and each sub block could be transferred to and from the vehicle at another access point along the road.

The present invention has been described with a certain degree of particularity, however those versed in the art will readily appreciate that various modifications and alterations may be carried out without departing from the spirit and scope of the following claims.

1. A vehicle communication system comprising a combined radar and wireless communication system coupling a plurality of vehicles.

2. The system according to claim 1, further comprising a plurality of access points which are coupled for wireless communication to said plurality of vehicles, where said access points use standard communication protocols and located in a plurality of locations.

3. The system according to claim 2, wherein at least one of said access points communicates with vehicles when they are stationary and in motion.

4. The system according to claim 2, wherein at least one of said access points provides Point of Presence (POP) to the Internet.

5. The system according to claim 2, wherein at least one of said access points provides push/pull information services.

6. The system according to claim 2, wherein at least one of said access points includes a sub-system for providing broadcast services.

7. The system according to claim 2, wherein at least one of said access points or vehicles includes a sub-system for pushing/pulling large information blocks by dividing them into several sub blocks, transitioning/receiving each sub-block in a separate access point, and automatically combining it in the vehicle/access point.

8. The system according to claim 1, wherein said radar communication system further includes a waveform generator for synthesizing a combined radar and information waveform.

9. The system according to claim 8, further comprising a radar processor coupled to said waveform generator, and a communication processor coupled to said waveform generator, for respectively providing waveforms and information to be transmitted, from which said waveform generator synthesizes a combined waveform.

10. The system according to claim 9, further comprising an RF front end for transmitting said combined waveform.

11. The system according to claim 1, further comprising:
an RF front end mounted in a vehicle;
at least one antenna mounted on said vehicle and coupled to said RF front end;
a communication/radar splitter coupled to said RF front end for splitting combined radar and information waveforms received in said RF front end;
a communication processor coupled to said communication/radar splitter for processing information received and to be transmitted;
a radar processor coupled to said communication/radar splitter for processing radar waveforms received and to be transmitted;
a waveform generator coupled to said communication processor and said radar processor for synthesizing a combined radar and information waveform and transferring it to said RF front end for transmission.

12. The system according to claim 11, further comprising
an information processor and data fusion module for receiving information from said radar processor, said communication processor and external sources and processing all said information.

13. The system according to claim 11, wherein said at least one antenna is an array of antennas.

14. The system according to claim 12, wherein said at least one antenna is an array of antennas.

15. The system according to claim 12, wherein said external sources include sensors monitoring internal vehicle parameters.

16. The system according to claim 12, wherein said external sources include a GPS/GIS information source.

17. The system according to claim 12, wherein said external sources include a rate-gyro information source.

18. The system according to claim 1, wherein said system is integrated with other sensors within an Intelligent Transportation System (ITS).

19. A method for vehicle communication comprising coupling a plurality of vehicles by means of a combined radar and wireless communication system.

20. The method according to claim 19, including transmitting a combined radar and information waveform between vehicles.

21. The method according to claim 19, further comprising the steps of:
providing, to a waveform generator, waveforms from a radar processor and information to be transmitted from a communication processor; and
synthesizing, in said waveform generator, a combined waveform to be transmitted.

22. The method according to claim 19, further comprising fusing data from external sources with said information to be transmitted before said step of synthesizing.

23. The method according to claim 22, wherein said step of fusing includes data fusion with GPS/GIS information for predicting road curves to improve radar performance.

24. The method according to claim 19, further comprising coordinating operation of at least two vehicles, thereby improving vehicle safety.

25. The method according to claim 19, further comprising coordinating operation of internal vehicle sensors between at least two vehicles.

26. The method according to claim 19, further comprising coordinating the operation of radar sensors to limit mutual interference problems.

27. The method according to claim 19, further comprising sharing sensor information between at least two vehicles.

28. The method according to claim 19, further comprising coupling by wireless communication at least one access point with said plurality of vehicles, and relaying information between at least one vehicle and said access point.
